(19) United States
(12) Patent Application Publication
(10) Pub. No.: US 2011/0167972 A1
(43) Pub. Date: Jul. 14, 2011

(54) FOAM CUTTING APPARATUS AND METHOD

(75) Inventors: David Gilliver, South Windsor (AU); Brett Lindsay, South Windsor (AU)

(73) Assignee: PRECISION FOAM TECHNOLOGIES PTY LTD., South Windsor (AU)

(21) Appl. No.: 13/061,752

(22) PCT Filed: Sep. 3, 2009
(86) PCT No.: PCT/AU09/01150

§ 371 Date: Mar. 2, 2011

(30) Foreign Application Priority Data
Sep. 12, 2008 (AU) 2008904769
Sep. 15, 2008 (AU) 2008904778
Oct. 27, 2008 (AU) 2008905526

(51) Int. Cl. B26D 7/08; B26D 7/01

(52) U.S. Cl. 83/19; 83/176

(57) ABSTRACT

The present invention comprises a protrusion cutting apparatus (30) for cutting a closed-cell foam product (32) comprising a support surface (36) adapted to support the foam product (32); a template (34) having an opening, the template (34) being movable relative to the support surface (36) to compress the foam product (32) between the support surface (36) and the template (34) so that a portion of the foam product (32)protrudes through the opening; a cutting tool (40) adapted to cut the foam product (32) adjacent to the template (34) so that the portion of the foam product (32) protruding through the opening is cut from the foam product (32); and one or more air vents (42) formed in the support surface (36) to allow air trapped between the compressed foam product (32) and the support surface (36) to escape.

### FIELD OF THE INVENTION

The present invention relates to foam cutting apparatus and methods. In particular, the present invention relates to foam cutting apparatus and methods for use in cutting closed cell foam products. However, the apparatus and methods could also be used in respect of other compressible foam products.

### BACKGROUND OF THE INVENTION

In the foam product manufacturing industry, foam products are cut to a desired shape in a number of different ways. Complex shapes often require multiple pieces of foam to be individually cut and then bonded together to form the complex shape.

One method of producing integral complex shapes in a consistent manner involves compression cutting, which is used to cut foam products out of foam blocks or sheets. The foam is compressed between two surfaces, typically between a support surface and a template or between a roller and a moving template.

As the foam is compressed between the two surfaces, the foam expands into recesses in the template and consequently, different portions of the foam product undergo different degrees of compression, depending on the depth of recesses in the template. This creates a varying compression profile in the foam product. A cutting tool is then used to cut the foam adjacent to the template. Accordingly, as the foam product is cut, the varying compression profile in the foam product creates a cutting profile that generally reflects the shape of the template.

An alternative method of cutting shaped foam products is protrusion cutting, in which the foam is compressed between a support surface and a template having an opening rather than a recess, so that a portion of the foam protrudes through the opening. As with the compression cutting process, a varying compression profile is created in the foam product. A cutting tool is then used to cut away the portion of the foam that protrudes through the opening. Accordingly, as the foam product is cut, the varying compression profile in the foam product creates a cutting profile that produces a smooth curved surface.

Foam products generally have an open cell structure, meaning that the pores formed in the foam product are interconnected and allow the passage of air from one pore to the next. However, it is possible to produce foam products having a closed cell structure, meaning that the pores formed in the foam product are not interconnected, preventing the passage of air between pores.

The compressive strength of the foam product varies greatly between open and closed cell structures and closed cell foam products display certain characteristics that are advantageous over open cell foam products in certain applications. One such characteristic is the ability of closed cell foams to provide a seal.

One advantage of the protrusion cutting process is that the portion of foam that results in the cut foam product is not subjected to the same extreme compressive forces as the foam in the compression cutting process. The extreme compressive forces in compression cutting can rupture the pores in a closed cell foam and compromise the closed cell nature of the foam. Further, the compressive forces required for compression cutting a closed cell foam are much greater than for an open cell foam and as a result, some compression cutting machines have difficulty processing closed cell foam. Further, as the compressive forces required for compression cutting are much greater than for protrusion cutting, this can limit the maximum density of foam materials that can be cut to produce high definition foam products.

However, protrusion cutting does not allow a foam product to be cut with a central aperture. In order to cut a foam product with an internal aperture, the aperture needs to be separately cut after the protrusion cutting operation. Using traditional aperture cutting techniques, it is not possible to produce a foam product with a curved profile adjacent to the aperture and traditional techniques typically result in internal apertures having steep walls, sharp edges and a rough finish.

Compression cutting and protrusion cutting generally work well with low density open cell foam material, producing consistent cut foam products with uniformly smooth surfaces.

However, when closed cell foam is used, the process often results in foam products having an inconsistent, non-uniform surface profile, product to product.

Investigations revealed that in the protrusion cutting process, the compression of the foam product between the support surface and the template often results in small pockets of air being trapped between the closed cell foam and the support surface. Similarly, in the compression cutting process, small pockets of air get trapped between the closed cell foam and the template.

Accordingly, it is generally not possible to produce consistent, high-definition, multi-contoured foam products from closed cell foam using existing traditional protrusion cutting or compression cutting techniques.

### OBJECT OF THE INVENTION

It is an object of the present invention to substantially overcome or at least ameliorate one or more of the above disadvantages, or to provide a useful alternative.

### SUMMARY OF THE INVENTION

In a first aspect, the present invention provides a compression cutting apparatus for cutting a closed-cell foam product comprising:
a support surface adapted to support the foam product;
a template having an opening, the template being movable relative to the support surface to compress the foam product between the support surface and the template so that a portion of the foam product projects through the opening;
a cutting tool adapted to cut the foam product adjacent to the template so that the portion of the foam product projecting through the opening is cut from the foam product; and
one or more air vents formed in the support surface to allow air trapped between the compressed foam product and the support surface to escape.

Preferably, the apparatus further comprises a vacuum device in fluid communication with the air vents, the vacuum device being adapted to apply a suction force to the vents.

Optionally, the vents are arranged in a matrix of evenly spaced vents.

Preferably, the vents are holes having a diameter of between about 0.5 mm and 3 mm.

In a preferred embodiment, the apparatus further comprises fasteners for fastening the template to the support surface.

Optionally, the apparatus further comprises an auxiliary plate smaller than the opening and adapted to be arranged within the opening to compress the foam product between the auxiliary plate and the support surface.

Optionally, the apparatus further comprises a shim adapted to be secured to the support surface within the opening between the support surface and the foam product to further protrude a portion of the foam product through the opening.

In a second aspect, the present invention provides a method of compression cutting a closed cell foam product, said method including the steps of:
placing the foam product between a support surface and a template having an opening;
compressing the foam product between the template and the support surface so that a portion of the foam product projects through the opening;
venting air from between the foam product and the support surface through air vents in the support surface; and
cutting the foam product by passing a cutting tool across an outer surface of the template to cut the portion of the foam product projecting through the opening away from the foam product.

In a preferred embodiment, the method further comprises the step of:
applying a vacuum force to the air vents.

Preferably, the method further comprises the step of:
securing the template to the support surface using fasteners after the step of compressing the foam product and before the step of cutting the foam product.

In a third aspect, the present invention provides a compression cutting apparatus for cutting a closed-cell foam product comprising:
a support surface;
a compression belt spaced from the support surface;
a template having a recess and adapted to receive the foam product, the template being movable relative to the compression belt, wherein the compression belt is adapted to compress the foam product into the recess as the temple passes between the compression belt and the support surface;
a cutting tool arranged adjacent to the compression belt, the cutting tool adapted to cut the compressed foam product as the template passes the compression belt; and
one or more air vents extending from the recess through the template to allow air trapped between the compressed foam product and the template to escape from the recess.

In a preferred embodiment, the compression belt and cutting tool are stationary and the template is movable along the support surface.

In a fourth aspect, the present invention provides a method of compression cutting a closed cell foam product, said method including the steps of:
placing the foam product on a movable template having a recess;
compressing the foam product into the recess by passing the template and foam product between a support surface and a compression belt;
venting air from between the compressed foam product and the recess of the template through air vents in the template; and
cutting the compressed foam product by passing the template between a cutting tool and the support surface.

In a fifth aspect, the present invention provides a protrusion cutting apparatus for cutting a foam product comprising:
a support surface adapted to support the foam product;
a template having an opening, the template being movable relative to the support surface to compress the foam product between the support surface and the template so that a portion of the foam product projects through the opening; and
a cutting tool adapted to cut the foam product adjacent to the template so that the portion of the foam product projecting through the opening is cut from the foam product; and
an auxiliary plate smaller than the opening and adapted to be secured to the support surface within the opening.

In a preferred embodiment, the auxiliary plate is adapted to compress the foam product between the auxiliary plate and the support surface.

Preferably, the auxiliary plate is a shim adapted to be secured to the support surface between the foam product and the support surface.

Optionally, the apparatus further comprises one or more air vents formed in the support surface to allow air trapped between the compressed foam product and the support surface to escape.

In a sixth aspect, the present invention provides a method of compression cutting a foam product, said method including the steps of:
placing the foam product between a support surface and a template having an opening;
compressing the foam product between the template and the support surface so that a portion of the foam product projects through the opening;
arranging an auxiliary plate within the opening of the template; and
cutting the foam product by passing a cutting tool across an outer surface of the template to cut away the portion of the foam product projecting through the opening.

In one preferred embodiment, the auxiliary plate is movable relative to the support plate to compress the foam product between the support surface and the auxiliary plate.

In an alternative embodiment, the auxiliary plate is a shim secured to the support surface between the foam product and the support surface to further protrude a portion of the foam product through the opening.

Preferably, the method further comprises the step of:
venting air from between the foam product and the support surface through air vents in the support surface.

### BRIEF DESCRIPTION OF THE DRAWINGS

A preferred embodiment of the invention will now be described by way of specific example with reference to the accompanying drawings, in which:

FIGS. 1 and 2 show a prior art compression cutting device, with a closed cell foam product in an uncompressed and compressed state respectively;

FIG. 3 depicts a compression cutting device with a closed cell foam product in a compressed state;

FIGS. 4 and 5 depict a further alternative compression cutting device for compression to cutting a closed cell foam product;

FIGS. 6A to 6D depict a process and apparatus for compression cutting a foam product; and

FIG. 7 depicts an alternative process and apparatus for compression cutting a foam product.

### DETAILED DESCRIPTION OF THE DRAWINGS

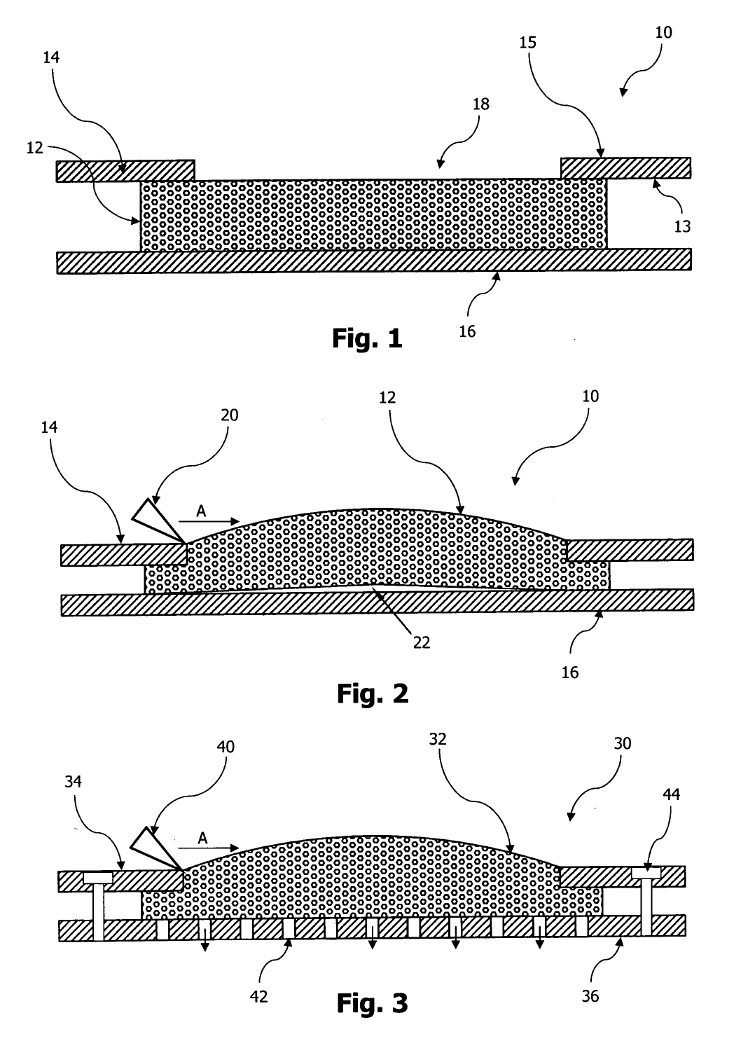

FIGS. 1 and 2 show a simple protrusion cutting apparatus 10 for cutting a foam product 12. The apparatus 10 includes a template 14, having opposing planar inner and outer surfaces 13, 15, and a support surface 16. An opening 18 is formed through the template 14.

Prior to cutting, the foam product 12 is compressed between the inner surface 13 of the template 14 and the support surface 16, resulting in the configuration shown in FIG. 2, such that a portion of the foam product 12 protrudes through the opening 18 and above the outer surface 15 of the template 14. A cutting tool 20 is then used adjacent to the outer surface 15 of the template 14 to cut the foam product 12 across the plane of the outer surface 15 of the template 14 in the direction of Arrow A. The cutting tool 20 cuts away the portion of the foam product 12 that protrudes above the outer surface 15 of the template 14, producing a dome shaped cut foam product.

As shown in FIG. 2, in a protrusion cutting process, when the foam product 12 comprises a closed cell foam, air caught between the foam product 12 and the support surface 16 is unable to escape through the foam product 12 and creates bubbles 22 between the foam product 12 and the support surface 16.

Similarly, when a closed cell foam product is cut using compression cutting, the compression of the foam product between the template and the compression surface often results in bubbles or small pockets of air being trapped between the foam product and the template. These small pockets of air create inconsistencies in the compression of the foam product and as a result cause inconsistencies in the profile of the cut foam product.

FIG. 3 depicts a protrusion cutting apparatus 30 for protrusion cutting a closed cell foam product 32. The apparatus 30 has a support surface 36, a template 34 with an opening 38 and a cutting tool 40 for cutting away the portion of the foam product 32 that protrudes above the outer surface of the template 34.

The support surface 36 includes a plurality of air vents 40 extending through the support surface 36. These air vents 40 allow any air trapped between the support surface 36 and the foam product 32 to escape through the support surface 36. The air vents 40 are typically circular holes and have a diameter of between about 0.5 mm and 3 mm. Fasteners 42, such as bolts or clamps, are typically used to secure the template 34 to the support surface 36. A vacuum source can be connected to the air vents 40 to assist in venting trapped air from between the support surface 36 and the foam product 32.

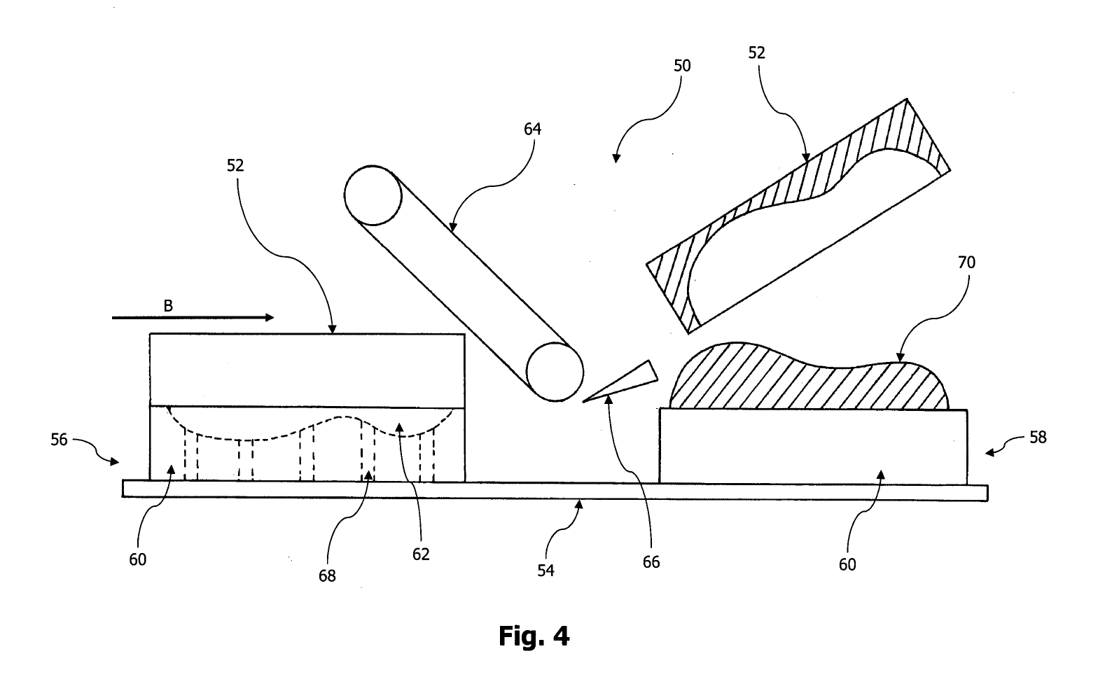

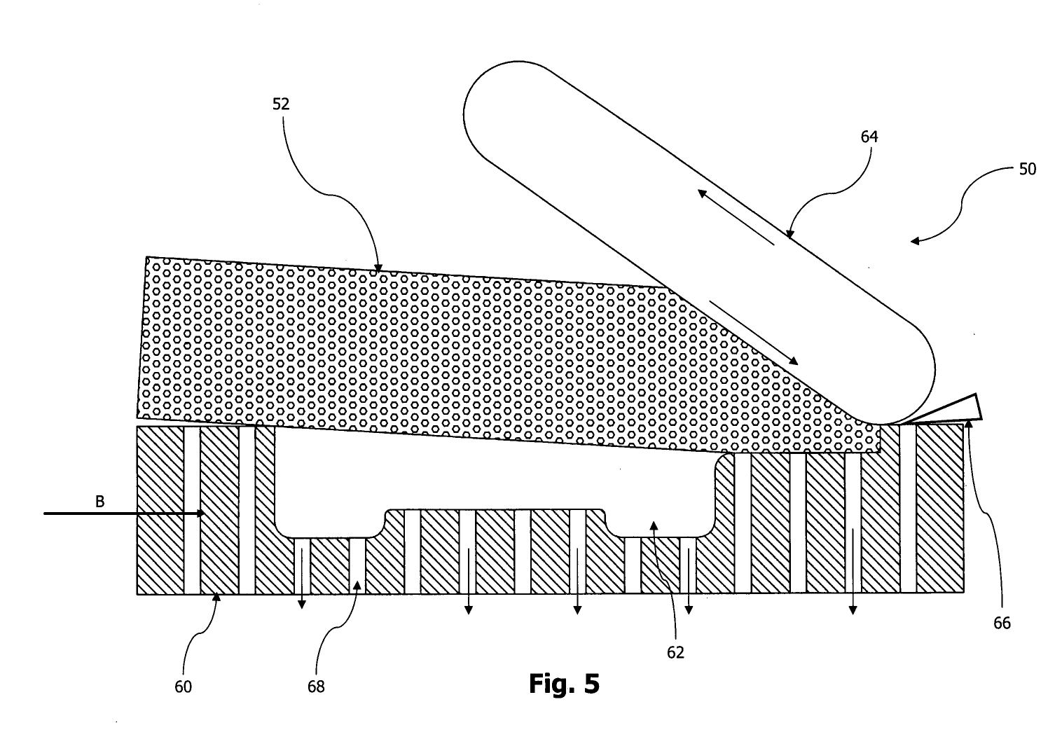

FIGS. 4 and 5 show a compression cutting apparatus 50 for cutting a foam product 52. The apparatus 50 includes a support surface 54 having an upstream end 56 and a downstream end 58. A movable template 60, having a recess 62, is adapted to move along the support surface 54 from the upstream end 56 to the downstream end 58 during operation. The apparatus 50 further includes a compression belt 64 and a cutting tool 66, each spaced from the support surface 54 sufficiently to allow the template 60 to pass between the support surface 54 and both the compression belt 64 and cutting tool 66. The cutting tool 66 is arranged immediately downstream of the compression belt 64. The template 60 also includes a plurality of air vents 68 extending vertically through the template 60.

In operation, the foam product 52 is mounted on the template 60 at the upstream end 56 of the support surface 54. Together the foam product 52 and the template 60 are fed downstream towards the compression belt 64 in the direction of Arrow B. As the foam product 52 contacts the compression belt 64, it is gradually compressed into the recess 62 of the template 60. As the template 60 passes to the downstream side of the compression belt 64, the cutting tool 66 cuts the foam product 52.

During compression of the foam product 52 into the recess 62 of the template 60, any air that is trapped between the foam product 52 and the template 60 is able to escape via the air vents 68 provided in the template 60.

A vacuum source can be provided in fluid communication with the air vents 68 to apply a suction force to the air vents 68. This helps to evacuate air trapped between the foam product 52 and the template 60 and also serves to help suck the foam product 52 into the recess 62.

This prevents the formation of bubbles between the foam product 52 and the template 60 and consequently, a more consistent and uniform cut foam product 70 results from the cutting operation.

A further advantageous feature of the apparatus is that much smaller tolerances of the finished foam product can be achieved.

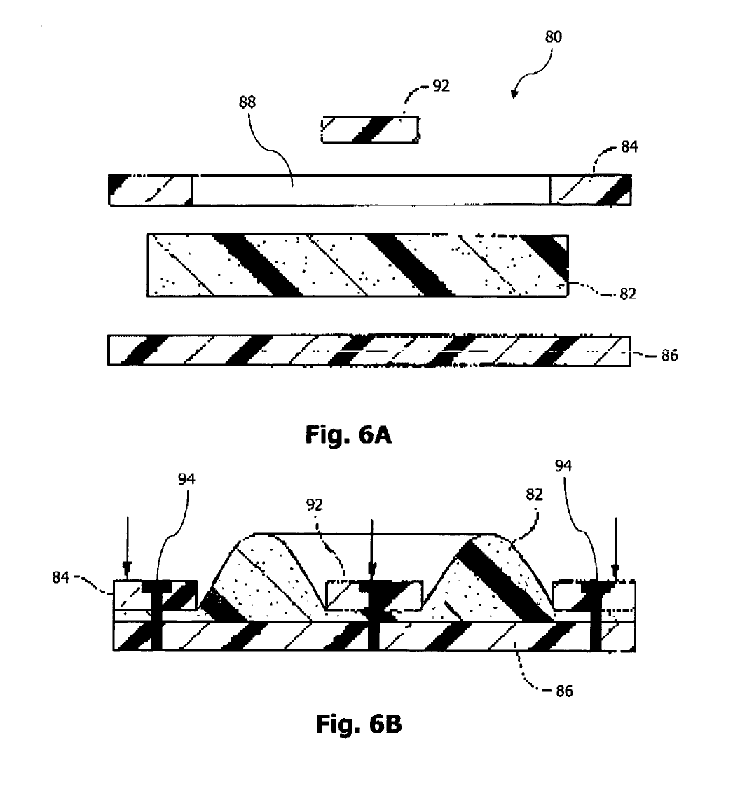

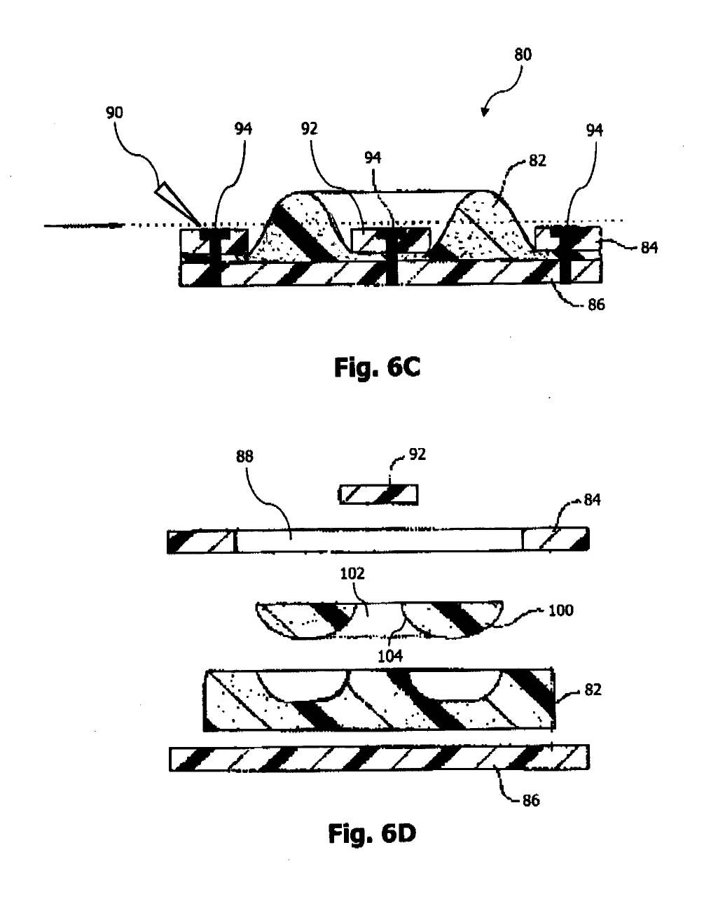

FIGS. 6A-D show a process and apparatus 80 for protrusion cutting a foam product 82 with an internal aperture. The apparatus 80 includes a support surface 86, a template 84 having an opening 88, and a cutting tool 90 similar to the apparatus 10 shown in FIG. 1. In addition, the apparatus 80 comprises an auxiliary plate 92, which is arranged within the opening 88 of the template 84. The template 84 and auxiliary plate 92 are typically secured to the support surface 86 by recessed screw fasteners 94, however many other securing arrangements, such as clamps, are possible.

The cutting tool 90 is used to cut away the portion of the foam product 82 that projects above the template 84. As shown in FIG. 6D the cut foam product 100 that results has an internal aperture 102 with a smooth curving inner surface 104.

As in the earlier embodiments discussed above, the support surface 86 may include air vents to evacuate air from between the foam product 82 and the support surface 86.

By employing this apparatus, it is possible to produce a foam product having an internal aperture via a single compression cutting process. Further, it is possible to produce a foam product having a surface that curves smoothly into the internal aperture, rather than the rough surface and sharp edges that result from die cutting a hole in the foam product.

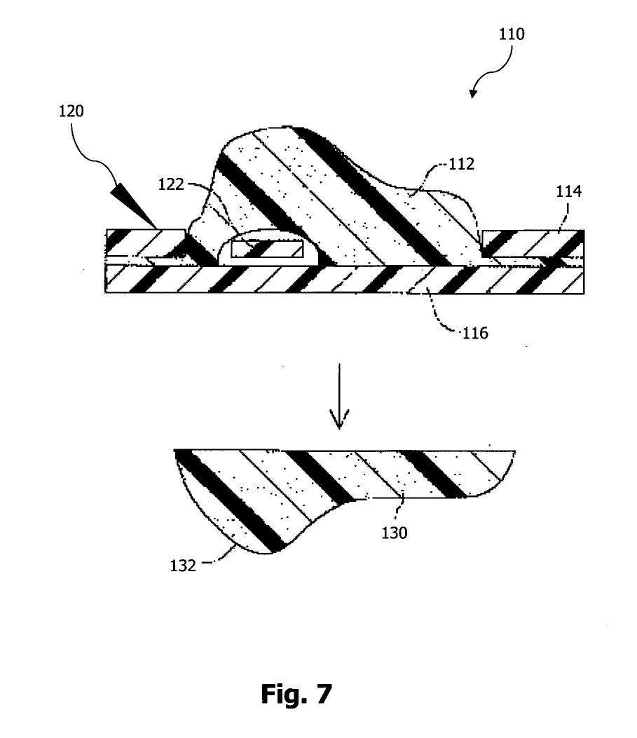

FIG. 7 depicts an alternative process and apparatus 110 for compression cutting a foam product 112 with a profiled surface. The apparatus 110 includes a support surface 116, a template 114 having an opening 118 and a cutting tool 120. In addition, the apparatus comprises an auxiliary plate, in the form of a shim 122, which is arranged within the opening 118 of the template 114, between the support surface 116 and the foam product 112. The shim 122 may comprise an assembly of layer plates and may have a complex or multi-contoured upper surface. Multiple shims 122 may also be used at different locations within the opening 118.

The cutting tool 120 is used to cut away the portion of the foam product 112 that projects above the template 114. The cut foam product 130 that results has a profiled outer surface with a raised section 132 corresponding to the positioning of the shim 122. In this way, the shims 122 can be used to create a cut foam product 130 with a complex contoured surface.

As in the earlier embodiments discussed above, the support surface 116 may include air vents to evacuate air from between the foam product 112 and the support surface 116.

The aforementioned apparatus and techniques allow high-definition multi-contoured shapes to be cut from both closed cell and open cell foam products. The ability to produce high-definition multi-contoured shapes from closed cell foams has a wide range of applications in the use of closed cell foam products in, for example, sealing functions.

Although the invention has been described with reference to specific examples, it will be appreciated by those skilled in the art that the invention may be embodied in many other forms.

The claims defining the invention are as follows:

1. A protrusion cutting apparatus for cutting a closed-cell foam product comprising:
a support surface adapted to support the foam product;
a template having an opening, the template being movable relative to the support surface to compress the foam product between the support surface and the template so that a portion of the foam product protrudes through the opening;
a cutting tool adapted to cut the foam product adjacent to the template so that the portion of the foam product protruding through the opening is cut from the foam product; and
one or more air vents formed in the support surface to allow air trapped between the compressed foam product and the support surface to escape.

2. The apparatus of claim 1, further comprising a vacuum device in fluid communication with the air vents, the vacuum device being adapted to apply a suction force to the vents.

3. The apparatus of claim 1, wherein the vents are arranged in a matrix of evenly spaced vents.

4. The apparatus of claim 1, wherein the vents are holes having a diameter of between about 0.5 mm and 3 mm.

5. The apparatus of claim 1, further comprising fasteners for fastening the template to the support surface.

6. The apparatus of claim 1, further comprising an auxiliary plate smaller than the opening and adapted to be arranged within the opening to compress the foam product between the auxiliary plate and the support surface.

7. The apparatus of claim 1, further comprising a shim adapted to be secured to the support surface within the opening between the support surface and the foam product to further protrude a portion of the foam product through the opening.

8. A method of protrusion cutting a closed cell polymeric foam product, said method including the steps of:
placing the foam product between a support surface and a template having an opening;
compressing the foam product between the template and the support surface so that a portion of the foam product projects through the opening;
venting air from between the foam product and the support surface through air vents in the support surface; and
cutting the foam product by passing a cutting tool across an outer surface of the template to cut the portion of the foam product projecting through the opening away from the foam product.

9. The method of claim 8 further comprising the step of:
applying a suction force to the air vents.

10. The method of claim 8 further comprising the step of:
securing the template to the support surface using fasteners after the step of compressing the foam product and before the step of cutting the foam product.

11. A compression cutting apparatus for cutting a closed-cell foam product comprising:
a support surface;
a compression belt spaced from the support surface;
a template having a recess and adapted to receive the foam product, the template being movable relative to the compression belt, wherein the compression belt is adapted to compress the foam product into the recess as the temple passes between the compression belt and the support surface;
a cutting tool arranged adjacent to the compression belt, the cutting tool adapted to cut the compressed foam product as the template passes the compression belt; and
one or more air vents extending from the recess through the template to allow air trapped between the compressed foam product and the template to escape from the recess.

12. The apparatus of claim 11 wherein the compression belt and cutting tool are stationary and the template is movable along the support surface.

13. The apparatus of claim 12, further comprising a vacuum device in fluid communication with the air vents, the vacuum device being adapted to apply a suction force to the vents.

14. The apparatus of claim 12, wherein the vents are arranged in a matrix of evenly spaced vents.

15. The apparatus of claim 12, wherein the vents are holes having a diameter of between about 0.5 mm and 3 mm.

16. A method of compression cutting a closed cell polymeric foam product, said method including the steps of:
placing the foam product on a movable template having a recess;
compressing the foam product into the recess by passing the template and foam product between a support surface and a compression belt;
venting air from between the compressed foam product and the recess of the template through air vents in the template; and
cutting the compressed foam product by passing the template between a cutting tool and the support surface.

17. The method of claim 16 further comprising the step of:
applying a suction force to the air vents.

18. A protrusion cutting apparatus for cutting a foam product comprising:
a support surface adapted to support the foam product;
a template having an opening, the template being movable relative to the support surface to compress the foam product between the support surface and the template so that a portion of the foam product projects through the opening; and
a cutting tool adapted to cut the foam product adjacent to the template so that the portion of the foam product projecting through the opening is cut from the foam product; and
an auxiliary plate smaller than the opening and adapted to be secured to the support surface within the opening.

19. The apparatus of claim 18 wherein the auxiliary plate is adapted to compress the foam product between the auxiliary plate and the support surface.

20. The apparatus of claim 18 wherein the auxiliary plate is a shim adapted to be secured to the support surface between the foam product and the support surface.

21. The apparatus of claim 18 further comprising:
one or more air vents formed in the support surface to allow air trapped between the compressed foam product and the support surface to escape.

22. A method of compression cutting a foam product, said method including the steps of:
placing the foam product between a support surface and a template having an opening;
compressing the foam product between the template and the support surface so that a portion of the foam product projects through the opening; and
securing an auxiliary plate to the support surface within the opening;
cutting the foam product by passing a cutting tool across an outer surface of the template to cut the portion of the foam product projecting through the opening away from the foam product.

23. The method of claim 22 wherein the auxiliary plate is movable relative to the support plate to compress the foam product between the support surface and the auxiliary plate.

24. The method of claim 22 wherein the auxiliary plate is a shim secured to the support surface between the foam product and the support surface to further protrude a portion of the foam product through the opening.

25. The method of claim 23 further comprising the step of:
venting air from between the foam product and the support surface through air vents in the support surface.

26. The method of claim 24 further comprising the step of:
venting air from between the foam product and the support surface through air vents in the support surface.
